(19) United States
(12) Patent Application Publication
(10) Pub. No.: US 2026/0055550 A1
(43) Pub. Date: Feb. 26, 2026

(54) ON-LINE INSPECTION OF CELLULOSE ACETATE TOW

(71) Applicant: Acetate International LLC, Irving, TX (US)

(72) Inventors: Philip Caenen, Lanaken (BE); Christophe Loix, Gellik (BE); Sander Vandenbon, Hasselt (BE)

(73) Assignee: Acetate International LLC, Irving, TX (US)

(21) Appl. No.: 19/305,504

(22) Filed: Aug. 20, 2025

Related U.S. Application Data
(60) Provisional application No. 63/685,551, filed on Aug. 21, 2024.

(51) Int. Cl. D06H 3/08; D01F 2/28; D02G 1/12; G06T 7/00

(52) U.S. Cl. CPC D06H 3/08; D01F 2/28; D02G 1/12; G06T 7/0004; G06T 2207/30108

(57) ABSTRACT

Disclosed are improved methods for inspecting tow for contamination, defects, and/or imperfections, for example cellulose acetate tow. The present disclosure can also relate to processes for producing cellulose acetate tow that involve detecting and analyzing contamination, defects, and/or imperfections in the tow. The methods can result in cellulose acetate that has fewer contamination, defects, and/or imperfections than has been previously achieved.

### CROSS-REFERENCE TO RELATED APPLICATIONS

This Application claims priority to U.S. Provisional Application No. 63/685,551, filed on Aug. 21, 2024, the entire contents and disclosures of which are incorporated by reference herein.

### FIELD OF THE INVENTION

The present invention relates generally to improved methods for inspecting tow, for example cellulose acetate tow. The present invention can also relate to processes for producing cellulose acetate tow that involve detecting and analyzing contamination, defects, and/or imperfections in the tow. The methods can result in cellulose acetate that has fewer contamination, defects, and/or imperfections than has been previously achieved.

### BACKGROUND OF THE INVENTION

Cellulose esters such as cellulose acetate are known for their robust uses, especially as filaments and fibers. Indeed, cellulose acetate is one of the principal types of synthetic fibers. As interest in the materials increases, the availability of high-quality cellulose acetate substantially free of defects is desirable.

Traditionally, cellulose acetate product is inspected manually (e.g., visually) by examining the tow visually for any possible signs of defects. Such methods are time-consuming and can lead to inconsistencies depending on the frequency of inspection and the various personnel involved. In addition, the amount of the tow inspected manually is usually only a small proportion of the total product. For example, in many cases, only 1% of the total tow product is actually inspected by a manual inspection process. Therefore, the need exists for improved methods for inspecting the tow with improved speed, ease of use, and consistency.

### SUMMARY OF THE INVENTION

In some aspects, the present disclosure relates to a method for inspecting tow, comprising: providing a tow band; illuminating the tow band with a light; capturing an image of the light illuminating and/or reflecting off the tow band; and analyzing the image for defects in the tow band. The tow can comprise cellulose acetate, for example. In some embodiments, the light can be a visible light. In other embodiments, the light is not a visible light, for example an infrared or an ultraviolet light. In some embodiments, analyzing the image for defects involves analyzing using computer software. In some, but not all, embodiments, analyzing the image for defects can comprise isolating a color channel of the image. The method can also comprise assigning a score to any defects detected, in some embodiments. The score might be used in approving or rejecting the tow, for example. In some cases, the above method can be performed after the tow has been crimped and/or dried. In some embodiments, the above method is carried out before forming the tow into layers or bales.

Some embodiments of the disclosure involve a process for making a cellulose acetate tow comprising the steps of: spinning a dope comprising a solution of cellulose acetate and a solvent; taking-up the spun cellulose acetate filaments; forming a tow from the cellulose acetate filaments; plasticizing the tow; crimping the plasticized tow; drying the crimped tow; illuminating the dried tow band with a light; capturing an image of the light illuminating the dried tow band; analyzing the image for defects in the dried tow band; and baling the dried crimped tow. In some embodiments, the light can be a visible light. In other embodiments, the light is not a visible light, for example an infrared or an ultraviolet light. In some embodiments, analyzing the image for defects involves analyzing the image using computer software. In some, but not all, embodiments, analyzing the image for defects can comprise isolating a color channel of the image. The method can also comprise assigning a score to any defects detected, in some embodiments. The score might be used in approving or rejecting the tow, for example. By using the methods described herein, the cellulose acetate product can have less defects compared to cellulose acetate tow using convention methods.

### BRIEF DESCRIPTION OF THE DRAWINGS

The present invention will be better understood in view of the appended non-limiting figure, in which:

FIG. 1 is a schematic illustration of a tow production process according to the present disclosure.

FIG. 2 is a side elevational view of a stuffer box crimper as part of the tow production process, parts broken away for clarity.

FIG. 3 is a top plan view of the stuffer box crimper in FIG. 2, parts broken away for clarity.

FIG. 4 is a front elevational detail view of the entry area of the stuffer box crimper in FIG. 2, parts broken away for clarity.

FIG. 5 is a diagram of one configuration of a camera, light, and tow band system.

### DETAILED DESCRIPTION OF THE INVENTION

### I. Introduction

The present disclosure is directed to improved methods for inspecting tow for defects or imperfections, for example cellulose acetate tow. The present invention can also relate to processes for producing cellulose acetate tow that involve detecting and analyzing defects or imperfections in the tow. The methods can result in cellulose acetate products, such as tow bales, that have fewer defects or imperfections than has been previously achieved.

As noted, cellulose acetate is usually inspected manually by examining the tow visually for defects. Such methods are time-consuming and can lead to inconsistencies dependent on the frequency of inspection and the personnel involved. The present invention, however, takes a novel approach by using improved techniques to inspect the tow for defects.

The method for inspecting tow can involve illuminating tow, such as in the form of a tow band, with light. Embodiments can involve capturing and/or analyzing an image of the light illuminating or reflecting off the tow band to identify defects in the tow. In some cases, the results can be used to accept, reject, and/or grade the tow.

### II. Process for Making Cellulose Ester

In general, tow (e.g., tow for cigarettes or for aerosol-generating devices) is made by spinning a dope into a plurality of filaments, taking up the filaments, lubricating the filaments, forming a tow by bundling a plurality of the filaments, crimping the tow, drying the crimped tow, and baling the dried crimped tow.

A dope is a solution of the polymer and solvent. The preferred polymer is cellulose acetate and the preferred solvent is acetone. The cellulose is exhaustively acetylated with the acetylating agent to produce a derivatized cellulose having a high degree of substitution (DS) value. Cellulose acetate suitable for use in as cigarette or aerosol-generating device filter material can have a degree of substitution of less than 3.0, preferably in the range of 2.2 to 2.8, and most preferably in the range of 2.4 to 2.6, for example. In some aspects, the cellulose acetate has a degree of substitution from 2 to 2.6. Cellulose acetate, as used herein, refers to cellulose diacetate.

In some embodiments, the filaments of cellulose acetate can range from 1 to 40 denier per filament (dpf) (e.g, from 21 to 40 dpf, from 1 to 25 dpf, or from 1 to 10 dpf, from 15 to 40 dpf, from 17 to 40 dpf, from 18 to 40 dpf, from 20 to 40 dpf, from 23 to 40 dpf, from 25 to 40 dpf, or from 30 to 40 dpf), for example. In some embodiments, the filaments of cellulose acetate can have a dpf of less than 12.5 (e.g., from 1 to 12.4, from 5 to 12, from 6 to 12, or from 8 to 12). The filaments may have any cross-sectional shape, including, but not limited to, circular, crenulated, Y, X, and dogbone. In some embodiments, the tow ranges from 10,000 to 100,000 total denier (e.g., from 10,000 to 80,000 total denier, from 15,000 to 80,000 total denier, from 15,000 to 60,000 total denier, from 20,000 to 50,000 total denier). In some embodiments, the tow has a width (lateral edge to lateral edge) of less than 3 inches (8 cm) exiting the crimper.

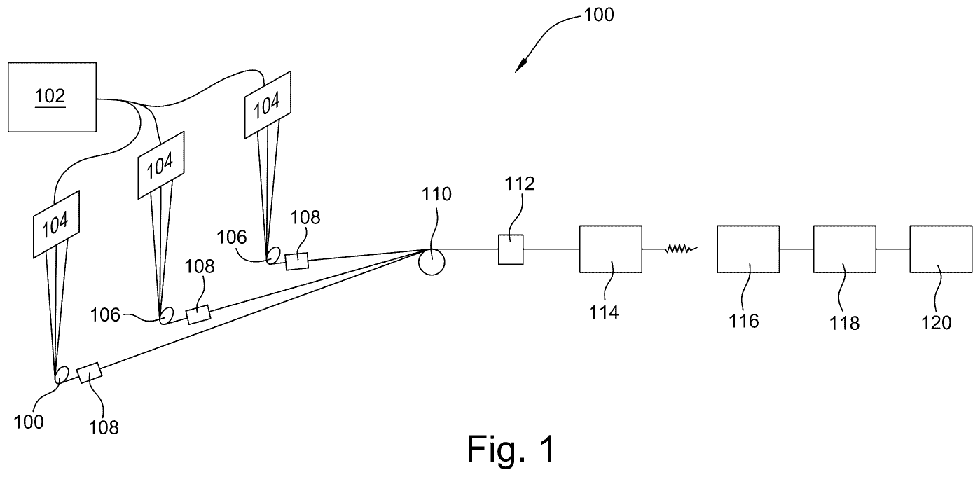

Referring to FIG. 1, a tow (e.g., a cigarette tow) process 100 is shown. Dope preparation station 102 feeds a plurality of cabinets 104 (only three shown, without being limited). In cabinets 104, fibers are produced, in a conventional manner. The fibers are taken-up on take-up roller 106. These fibers are lubricated at a lubrication station 108 with a finish (discussed in greater detail below). These lubricated fibers are bundled together to form a tow on a roller 110. The tow is plasticized at a plasticizing station 112 (discussed in greater detail below). The tow is then passed through a crimper 114 (discussed in greater detail below). The crimped tow is dried in dryer 116. In some embodiments, the dried tow can be inspected at station 118. The improved methods for inspection of the tow are described below. The dried crimped tow is then baled at baling station 120. Although the tow inspection is shown between the dryer 116 and the baling station 120 in this embodiment, the tow inspection can also or alternatively be performed at different points in the process.

Filter rods for cigarettes or aerosol-generating devices can be made by de-baling and opening the tow, and running the open tow through a rodmaking machine. In the rodmaker, the tow is opened or “bloomed,” formed into a rod, and wrapped with paper, referred to as plugwrap. The filter rod is subsequently cut to a specified length and attached to a cigarette or aerosol-generating device.

While the instant invention is directed primarily to methods for making and inspecting tow, the invention may also be used in the production of any spinnable polymer. Such spinnable polymers include, but are not limited to, polyolefins, polyamides, polyesters, cellulose esters and ethers and their derivatives, polylactic acid (PLA), and the like.

In some embodiments, the lubricant (or finish) applied to the fibers at the first lubrication station 108 comprises: mineral oil, emulsifiers, and water. The mineral oil can be a liquid petroleum derivative, for example. The preferred mineral oil is a water white (i.e., clear) mineral oil. In some embodiments involving mineral oils, the mineral oil can have a viscosity of 80-95 SUS (Sabolt Universal Seconds) measured at 100° F. The emulsifiers are preferably a mixture of emulsifiers. The preferred mixture of emulsifiers comprises sorbitan monolaurate and POE 20 sorbitan monolaurate. The water is preferably de-mineralized water, de-ionized water, or otherwise appropriately filtered and treated water. In some embodiments, the lubricant may consist of: 62.0-65.0 wt. % mineral oil, 27.0-28.0 wt. % emulsifiers, and 8.0-10.0 wt. % water; preferably, 63.5-64.0 wt. % mineral oil, 27.5-28.0 wt. % emulsifier, 8.3-8.5 wt. % water. In some embodiments, the emulsifier mixture consists of (it being understood that some water is included in these materials but is not included herein): 50.0-52.0 wt. % sorbitan monolaurate and 48.0-50.0 wt. % POE (20) sorbitan monolaurate; preferably 50.5-51.5 wt. % sorbitan monolaurate and 48.5-49.5 wt. % POE (20) sorbitan monolaurate; and most preferably, 50.9-51.4 wt. % sorbitan monolaurate and 49.6-49.1 wt. % POE (20) sorbitan monolaurate. The lubricant is then mixed with water (e.g., de-ionized or de-mineralized water) to form a 3-15 wt. % water emulsion, for example. In some embodiments, the water emulsion is added on to the tow to obtain a final range from 0.7-1.8 wt. % FOY (i.e., after the dryer), preferably about 1.0 wt. % FOY (FOY is finish on yarn and represents the lubricant less added water).

In some embodiments, after the fibers are bundled into a tow and before the tow enters the crimper, the tow is plasticized at the plasticizing station 112. The plasticizing station 112 can be adjustable up and down and from side to side, so that the tow properly enters crimper 114 as will be more apparent in the discussion of the crimper below. The plasticizing station 112 can be spaced away from crimper 114, for example. Plasticizing station 112 can be placed before the crimper 114, so that the plasticizer added to the tow has a sufficient time to plasticize the tow. Preferably, plasticizer station 112 is at least one half (½) meter before the crimper nip, more preferably one meter before the crimper nip. The plasticizer station 112 adds a plasticizer, preferably water, most preferably de-mineralized water, to the tow. In some embodiments, the plasticizer is applied at a maximum rate to a point of excess spray-back from the crimper nip rolls. The application rate is preferably less than 300 cc/min at line speeds of 200-1,000 meters per minute with a tow of 10,000-100,000 total denier, most preferably 25-200 cc/min at line speeds of 200-1,000 meters per minute with a tow of 10,000-100,000 total denier. The applicator is preferably a “spool” type guide(s) adapted to deliver the plasticizer. Preferably, a pair of spool guides is used to insure proper wetting of both sides of the tow. In some embodiments, the spool guides may be spaced apart so that the tow runs therebetween in a straight line or the spool guides may be closely spaced so that the tow runs therebetween in an “S” shaped path. The surface of the spool guides may be flat or curved (e.g., concave, convex, wavy, or concaved/convexed). The spool guide may be made of ceramic material or ceramic coated, for example. The spool guide may be flanged or flangeless, for example. In some embodiments, the spool guide may have a plurality of openings through which the plasticizer is applied to the tow.

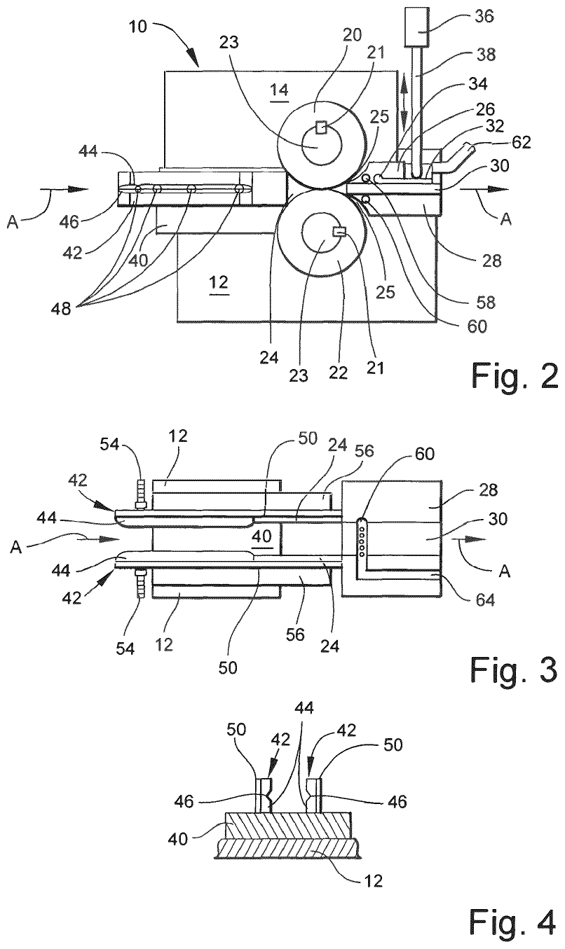

In the embodiment of FIG. 2, there is shown a stuffer box crimper 10. Crimper 10 has a base frame 12 and a top frame 14. Base frame 12 and top frame 14 are joined together, so that top frame 14 may move (or “float”) in relation to base frame 12. The tow travels through the crimper as indicated by arrows A.

In some embodiments, tow, not shown, is pulled through the crimper 10 by a pair of driven nip rollers 20, 22 that are mounted on shafts 23 and fixed in place via keys 21. Upper nip roller 20 is mounted on the top frame 14. Lower nip roller 22 is mounted on base frame 12. Shafts 23 are coupled to motors (not shown). The tow leaves the nip rollers 20, 22 and enters the stuffer box having a channel 30 and a flapper 32 located at the distal end of the channel 30. In the channel 30, the tow is folded perpendicular to its direction of travel as it encounters backpressure caused by the tow being shoved (or stuffed) into the channel 30 against the flapper 32. This folding creates the crimp in the tow.

Nip rolls 20, 22, are referred to as “induced crimp” rolls. The induced crimp rolls crease (or bend) the tow as it passes through the nip and thereby “trains” the tow where to crimp (e.g., influences the location of crimp in the tow by preferentially weakening areas of the tow to be crimped).

While in some embodiments, the induced crimp rolls be the nip rolls of the crimper, the invention is not so limited. The induced crimp rolls may be another pair of rollers located before the crimper 10. Also, the induced crimp rolls grip the tow thereby preventing slippage.

Either or both nip rolls may be an “induced crimp roll. ” One nip roll may have a smooth circumferential surface and the other may have an axially grooved circumferential surface, both rolls may have an axially grooved circumferential surface, or both rolls may have a smooth surface, for example. The axially grooved roll creases the tow and thereby trains it to crimp in a uniform manner. The grooved roll may be located either on the top or bottom of the pair, but it is preferred at the bottom.

The term “grooved” refers to any surface texturing that will “induce” crimp. Such surface texturing may include grooves, dimples, or other types of texturing. A surface having grooves is preferred. The grooves are preferably in the form of a sine curve, but may also be rectangular, triangular, or semicircular notches, grooves, or ridges with or without flat surfaces therebetween that extend axially (i.e., lateral to lateral) across the face of the roller. In some embodiments, these grooves may range from 10 to 100 grooves per inch (2.5 cm), preferably 25 to 75 grooves per inch (2.5 cm), most preferably 50 grooves per inch (2.5 cm). The groove depth (peak to trough) may range from 0.5 mils to 5.0 mils (12.5 micron to 150 microns), preferably 1-2 mils (25-50 microns).

Upper nip roll 20, the smooth roll, may be made of metallic or ceramic materials. Those materials include, but are not limited to, steel/alloy bonded titanium carbides, tungsten carbides, hipped or unhipped MgO stabilized zirconia, or hipped or unhipped Yttria stabilized zirconia (YTZP) (“hipped” refers to hot isostatic pressing). In some embodiments, the surface finish (texture) is no greater than 16 rms, with sharp lateral edges and free of chips.

Lower nip roll 22, the axially grooved roll, may be made of metallic or ceramic materials. Those materials include, but are not limited to, steel/alloy bonded titanium carbides, tungsten carbides, hipped or unhipped MgO stabilized zirconia, or hipped or unhipped Yttria stabilized zirconia (YTZP). In some embodiments, the surface finish (texture) is no greater than 12 rms, with sharp lateral edges, rounded groove edges, and free of chips.

In an alternate embodiment of the invention, nip rolls 20, 22 are not the “induced crimp” rolls mentioned above (i.e., no axial grooves on either roll 20, 22). In this embodiment, the nip rolls 20, 22 are made of solid ceramic materials. This means that the roll is ceramic (i.e., not merely a coating). The ceramic materials include unhipped or hipped MgO stabilized zirconia, or hipped or unhipped Yttria stabilized zirconia (YTZP). In some embodiments, the surface finish (texture) is no greater than 16 rms, with sharp lateral edges and free of chips.

In the embodiment shown in FIG. 3, cheek plates 24 are located on both lateral sides of the nip rollers 20, 22 and abut the doctor blades 25. The cheek plates 24 are used to keep the tow in the nip between the nip rollers 20, 22. The cheek plates 24 may be made of metal, ceramic, or ceramic coated metal.

In an embodiment, the stuffer box has an upper half 26 affixed to the top frame 14 and a lower half 28 affixed to the base frame 12. The halves when mated define a stuffer box channel 30. A flapper 32 is located in the distal end of the channel. Flapper 32 is preferably mounted to upper half 26 via a pivot 34, so that flapper 32 may swing into channel 30 and partially close same. Movement of flapper 32 may be controlled by an actuator 36 that is operatively coupled to flapper 32 via rod 38. Flapper 32 movement can be controlled to ensure uniformity of the crimp by any conventional means including, but not limited to weight, or pneumatic, or electrical, or electronic means.

Doctor blades 25 can be an integral part of the upper half 26 and lower half 28 of the stuffer box, for example. Doctor blades 25 are located next to (e.g., with a clearance of about 1 mil (25 microns)) the nip rolls 20, 22, so that tow does not stick to the rolls and is directed into channel 30.

In some embodiments, a steam injector 58 is located in the upper half 26 of the stuffer box. Steam injector 58 can be positioned as close to the end of the doctor blade 25 adjacent the nip roll 20 as practically possible, for example. In some embodiments, steam injector 58 is located between flapper 32 and the end of the doctor blade 25 adjacent to the nip roll 20. Steam injector 58 can be in communication with stuffer box channel 30. Steam injector 58 can allow steam to set and lightly bond the crimp of the tow in channel 30. Steam injector 58 may possess any type of suitable openings, such as a single or multiple slots or single or multiple holes. In some embodiments, steam injector 58 is a plurality of circular holes spanning the width of the channel 30, so that steam is distributed uniformly across the width of the tow in the channel 30. In some embodiments, the steam (delivered into the channel) is low-pressure steam at 100° C. The steam is preferably a low-pressure dry steam at 100° C. In some embodiments, the steam pressure is in the range of 0.01 to 5 psig. Preferably, the steam is filtered, through a 2 micron filter, to remove particulates from the steam and the steam is fed from the filter to the injector through stainless steel tubing. In some embodiments, the steam is controlled by needle valves (other suitable valves may be used) located closely adjacent to the stuffer box. Preferably, there is a water trap between the valve and the stuffer box. The steam pressure can vary depending upon the size and the shape of the holes/slots of the steam injector 58. Steam is directed to injector 58 via steam inlet 62 which is a flexible coupling, so that upper half 26 of the stuffer box may float with top frame 14, for example.

In some embodiments, a steam injector 60 is located in the lower half 28 of the stuffer box. Steam injector 60 can be positioned as close to the end of the doctor blade 25 adjacent the nip roll 22 as practically possible. Steam injector 60 is preferably located directly below injector 58 of the upper half 26 of the stuffer box. In some embodiments, steam injector 60 is in communication with stuffer box channel 30. Steam injector 60 can allow steam to set and lightly bond the crimp of the tow in channel 30. Steam injector 60 may possess any type of suitable openings, such as a single or multiple slots or single or multiple holes. In some embodiments, steam injector 60 is a plurality of circular holes spanning the width of the channel 30 (FIG. 3), so that steam is distributed uniformly across the width of the tow in the channel 30. In some embodiments, the steam (delivered into the channel) is low pressure steam at 100° C. The steam is preferably a low pressure dry steam at 100° C. In some embodiments, the steam pressure is in the range of 0.01 to 5 psig. Preferably, the steam is filtered, through a 2 micron filter, to remove particulates from the steam and the steam is fed from the filter to the injector through stainless steel tubing. In some embodiments, the steam is controlled by needle valves (other suitable valves may be used) located closely adjacent to the stuffer box. Preferably, there is a water trap between the valve and the stuffer box. The steam pressure can vary depending upon the size and the shape of the holes/slots of the steam injector 58. Steam is directed to injector 60 via steam inlet 64, for example.

In some embodiments, the total amount of steam injected into the stuffer box channel by the steam injectors 58/60 is in the range of 0.002-0.08 pounds of steam per pounds of tow, preferably 0.005-0.02 pounds of steam per pounds of tow.

In certain embodiments, the edges of the tow are lubricated prior to entry into the stuffer box crimper 10. Lubrication is preferably added immediately prior to entry into the stuffer box crimper 10. Lubrication is most preferably added to the tow edges immediately prior to the tow's entry into the nip between rolls 20, 22. This edge lubrication can minimize filament damage between the nip rolls and the cheeks plates. This edge lubricating system can be mounted on an alignment base 40 which is attached to base frame 12, for example. In the embodiments shown in FIG. 3, a fastening mechanism 56 allows the cheek plates 24 to be brought into position relative to the nip rolls 20, 22 (i.e., with shims and/or wedges). In the embodiments shown in FIG. 4, two edge lubrication applicators 42 are shown securely mounted onto base 40, so that when the tow enters the crimper 10, the edges of the tow may be lubricated with a suitable lubricant, such as water.

In some embodiments, dach edge lubrication applicator 42 comprises an applicator face 44 and backing plate 50. Backing plate 50 can be sufficiently long to support (i.e., extend behind) both the applicator face 44 and cheek plate 24 (FIG. 3). Applicator face 44 is affixed to backing plate 50, for example. The applicator face 44 is preferably flame spray ceramic coated to provide low friction and good wear. In some embodiments, cheek plate 24 is not affixed to plate 50, but instead is replaceably or removeably affixed. Applicator face 44 has a longitudinal groove 46, for example. Tow edges can be adapted to contact and run through the grooves 46 where they are lubricated. In some embodiments, dne or more orifices 48 (FIG. 2) are cut through applicator 42 and are in communication with grooves 46. The orifices 48 might be any number, size, or shape suitable to the task. The orifices 48 may be slots or circular holes. Preferably, the orifices 48 are round and of equal diameter. The diameter can be optimized for best distribution, for example, preferably equal to the height of the tow. In some embodiments, tnlets 54 supply the lubricant to applicators 42. The rate of lubricant addition via the applicator can vary depending upon numerous factors, including but not limited to, tow speed, tow size (total denier), filament size (dpf), and cross-sectional shape to mention but a few. In some embodiments, lubricant is added to below a maximum rate, the maximum rate reached when either the tow line flutters or there is excessive sprayback from the crimper. In some embodiments, the lubricant addition rate is less than 100 cc per minute per side, preferably less than 50 cc per minute per side, and most preferably between 10-50 cc/min/side.

Further, some embodiments may involve heating the tow bands before, after, and/or during crimping. While said heating may be used in conjunction with any crimp configuration, it may be advantageous to use said heating with a vertical and/or substantially vertical crimp configuration. Said heating may involve exposing the filaments of the tow band to steam, aerosolized compounds (e.g., plasticizers), liquids, heated fluids, direct heat sources, indirect heat sources, irradiation sources that causes additives in the filaments (e.g., nanoparticles) to produce heat, or any combination thereof.

Some embodiments may include conditioning the crimped tow band. Conditioning may be used to achieve a crimped tow band having a residual acetone content of about 0.5% or less w/w of the crimped tow band. Conditioning may be used to achieve a crimped tow band having a residual water content of about 8% or less w/w of the crimped tow band. Conditioning may involve exposing the filaments of the crimped tow band to steam, aerosolized compounds (e.g., plasticizers), liquids, heated fluids, direct heat sources, indirect heat sources, irradiation sources that causes additives in the filaments (e.g., nanoparticles) to produce heat, or any combination thereof.

In some embodiments, the tow inspection methods described herein can be carried out after the crimping, conditioning, and/or drying of the tow band. In some embodiments, the method is performed immediately after the tow exits the drier. In some embodiments, the method is performed at the last possible point in the production process in order to detect the maximum possible defects. In some embodiments, the tow inspection can be carried out before baling the tow.

In some embodiments, the method for inspecting tow can comprise illuminating the tow band with at least one light. In some embodiments, the light can be a visible light. Thus, the light can be a red, orange, yellow, green, blue, indigo, or a violet light, or combinations thereof. In other embodiments, the light is not a visible light, such as an infrared or ultraviolet light, for example. In some embodiments, the light can be an ambient light source. In other embodiments, the light is one other than the ambient light source. In some embodiments, the methods can involve more than one light source, for example two light sources, three light sources, or more. The multiple light sources can be the same type of light or different.

In some embodiments, the method for inspecting tow further comprises capturing at least one image of the light illuminating and/or reflecting off the tow band, for example by using a camera. Some embodiments can involve more than one camera, e.g., 2 cameras, at least 2 cameras, 3 cameras, at least 3 cameras, 4 cameras, at least 4 cameras, 5 cameras, at least 5 cameras, six cameras, at least 6 cameras, 7 cameras, at least 7 cameras, 8 cameras, or at least 8 cameras. In some embodiments, the at least one camera is monochromatic. In other embodiments, the at least one camera is polychromatic.

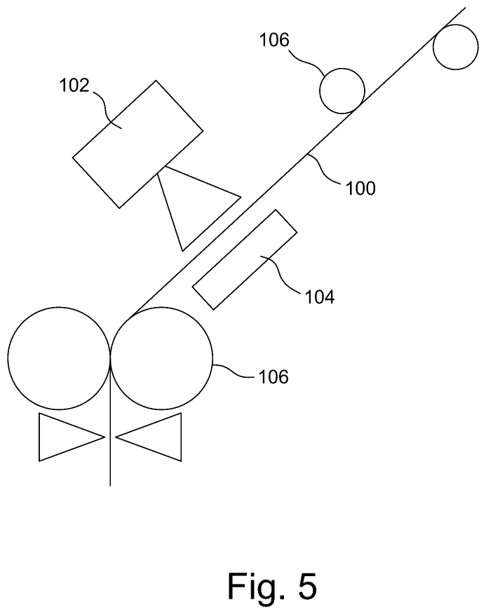

Various positional configurations of the light source, the tow, and the camera can be used. In some embodiments, the camera is positioned opposite the light source with the tow in between. In other embodiments, the camera can be positioned adjacent or proximal to the light source (e.g., on the same side of the tow band). FIG. 5 depicts one example of a configuration. A stationary camera 102 can be positioned some distance away (e.g., from 0.1 cm to 20 m) from the incoming product 100 (e.g., a moving tow band). Various rollers 106 can be used to move the incoming product band 100 past the stationary camera 102. In the embodiment, a light source 104 is positioned opposite the camera 102 to illuminate the incoming product 100. The camera 102 can then capture image(s) of the illuminated incoming product 100 for further analysis.

In some embodiments, the method for inspecting tow further involves analyzing the at least one image, for example, analyzing the at least one image for defects. Defects can be (but are not limited to), for example, a contamination in the tow band, a rough edge of the tow band, a loose edge of the tow band, a spot on the tow band (e.g., an oil spot), a hole in the tow band, split tow, an overwidth tow, an underwidth tow, or combinations thereof. In some situations, the defect can be visible to the naked eye. In other situations, the defect may not be visible to the naked eye. In some embodiments, analyzing the image for defects is carried out using computer software (e.g., a computer program). In some embodiments, the analysis of the image can involve scanning the image for anomalies indicative of a defect. In some embodiments, the analysis of the image can comprise isolating the color channel of the image. In some embodiments, the analysis can involve an on line evaluation of the tow to reference it to stored specifications or parameters, such as an acceptable width range, for example.

In some embodiments, the size of the at least one defect is measured, e.g., by analyzing the image. In some embodiments, the at least one defect is assigned a score, e.g, a score indicating the size and/or severity of the defect. For example, the at least one defect can be assigned a score, such as from 1 to 100, from 1 to 20, from 1 to 10, from 1 to 5, or from 1 to 3, with a higher number representing a larger and/or more severe defect (or a lower number representing a larger and/or more sever defect). In some embodiments, the score of the defect can be used to trigger a signal or an alarm to further inspect the tow band. In some embodiments, the score of the defect can be used to approve or reject the tow band. For example, the combined score over a length of tow band or a period of time, can be used to approve or reject that length of tow band. Thus, the method can lead to cellulose acetate product (e.g., cellulose acetate bales) with less defects than cellulose acetate tow product produced using conventional methods.

In some embodiments, the method of inspecting the tow can monitor for physical defects 100 percent of the time (or substantially 100 percent of time) during tow production. In other embodiments, the method can be used intermittently during tow production.

After the tow inspection, some embodiments of the present invention may include baling the crimped tow band to produce a bale. In some embodiments, baling may involve placing, e.g., laying, depositing, or arranging, the crimped tow band in a can in a pattern. It should be noted that can is used generically to refer to a container that may be in any shape, preferably square or rectangle, and of any material. As used herein, the term “pattern” refers to any design which may or may not change during placing. In some embodiments of the present invention, the pattern may be substantially zig-zag having a periodicity of about 0.5 cycles/ft to about 6 cycles/ft. In some embodiments, placing may involve puddling the crimped tow band with a puddling index of about 10 m/m to about 40 m/m. As used herein, the term “puddling” refers to allowing the tow band to lay at least partially on itself so as to place a greater actual length of tow band than linear distance on which it is placed. As used herein, the term “puddling index”refers to the length of tow band per linear distance on which it is placed.

In some embodiments of the present invention, baling may involve compressing the crimped tow band that has been placed in a suitable container. In some embodiments, baling may involve packaging the compressed crimped tow band. In some embodiments, the packaging may include at least one component like wrapping materials, vacuum ports (for releasing and/or pulling vacuum), securing elements, or any combination thereof. Suitable wrapping materials may include, but not be limited to, air-permeable materials, air-impermeable materials, films (e.g., polymeric films, polyethylene films, plastic wrap), heat-shrinkable films, cardboard, wood, woven materials (i.e., fabric composed of two sets of yarns interlaced with each other to form the fabric), non-woven materials (i.e., assemblies of textile fibers held together by mechanical or chemical means in a random web or mat, e.g., fused thermoplastic fibers), foil materials (e.g., metallic materials), and the like, or any combination thereof. Suitable securing elements may include, but not be limited to, VELCRO®, pins, hooks, straps (e.g., woven, non-woven, fabric, and/or metallic), adhesives, tapes, melt bondings, and the like, or any combination thereof. In some embodiments, at least a portion of the packaging (including any component thereof) may be reusable.

In some embodiments, bales may have dimensions ranging from about 30 inches (76 cm) to about 60 inches (152 cm) in height, about 46 inches (117 cm) to about 56 inches (142 cm) in length, and about 35 inches (89 cm) to about 45 inches (114 cm) in width. In some embodiments, bales may range in weight from 900 pounds (408 kg) to 2100 pounds (953 kg). In some embodiments, bales may have a density greater than about 300 kg/m³ (18.8 lb/ft³).

### Illustrations

Illustration 1: A method for inspecting tow, the method comprising: providing a tow band; illuminating the tow band with a light; capturing an image of the light illuminating the tow band; and analyzing the image for defects in the tow band.

Illustration 2: The method of illustration 1, wherein the tow band comprises cellulose acetate.

Illustration 3: The method of illustrations 1 or 2, wherein the light is a visible light.

Illustration 4: The method of any of the preceding illustrations, wherein the capture of the image is performed with a camera.

Illustration 5: The method of any of the preceding illustrations, wherein the image is analyzed using computer software.

Illustration 6: The method of any of the preceding illustrations, wherein analyzing the image comprises isolating the color channel of the image.

Illustration 7: The method of any of the preceding illustrations, wherein the method is carried out automatically at a predetermined time.

Illustration 8: The method of any of the preceding illustrations, wherein the method is carried out after the tow band has undergone drying.

Illustration 9: The method of any of the preceding illustrations, wherein the method is carried out before the tow band has been formed into layers or bales.

Illustration 10: The method of any of the preceding illustrations, wherein the light source is at a distance from 1 mm to 1 meter from the tow band.

Illustration 11: The method of any of the preceding illustrations, further comprising assigning a score to the defect.

Illustration 12: The method of illustration 11, further comprising approving or rejecting the tow based on the score of the defect.

Illustration 13: A process for making a cellulose acetate tow comprising the steps of: spinning a dope comprising a solution of cellulose acetate and a solvent, taking-up the as-spun cellulose acetate filaments, forming a tow from the cellulose acetate filaments, plasticizing the tow, crimping the plasticized tow, drying the crimped tow, illuminating the dried tow band with a light at an angle to the dried tow band, capturing an image of the light illuminating the dried tow band, analyzing the image for defects in the dried tow band, and baling the dried crimped tow.

Illustration 14: The process of illustration 13, further comprising approving or rejecting the tow based on the two based on the analysis of the image for defects.

Illustration 15: The process of illustration 13 or 14, wherein the cellulose acetate tow has less defects compared to cellulose acetate tow producing using conventional methods.

While the invention has been described in detail, modifications within the spirit and scope of the invention will be readily apparent to those of skill in the art. It should be understood that aspects of the invention and portions of various embodiments and various features recited above and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention. All patents and publications cited herein are incorporated by reference in their entirety.

We claim:

1. A method for inspecting tow, the method comprising:
a) providing a tow band;
b) illuminating the tow band with a light;
c) capturing an image of the light illuminating the tow band; and
d) analyzing the image for defects in the tow band.

2. The method of claim 1, wherein the tow band comprises cellulose acetate.

3. The method of claim 1, wherein the light is a visible light.

4. The method of claim 1, wherein the capture of the image is performed with a camera.

5. The method of claim 1, wherein the image is analyzed using computer software.

6. The method of claim 1, wherein analyzing the image comprises scanning the image for defects.

7. The method of claim 1, wherein the method is carried out automatically at a predetermined time.

8. The method of any of claim 1, wherein the method is carried out after the tow band has undergone drying.

9. The method of claim 1, wherein the method is carried out before the tow band has been formed into layers or bales.

10. The method of claim 1, wherein the source of the at least one light is at a distance of less than 20 meters from the tow band.

11. The method of claim 1, further comprising assigning a score to a defect detected during the analyzing step.

12. The method of claim 11, further comprising approving or rejecting the tow based on the score of the defect.

13. A process for making a cellulose acetate tow comprising the steps of:
spinning a dope comprising a solution of cellulose acetate and a solvent to produce as-spun cellulose acetate filaments;
taking-up the as-spun cellulose acetate filaments;
forming a tow from the cellulose acetate filaments;
plasticizing the tow;
crimping the plasticized tow;
drying the crimped tow;
illuminating the dried tow band with a light at an angle to the dried tow band;
capturing an image of the light illuminating the dried tow band;
analyzing the image for defects in the dried tow band; and
baling the dried crimped tow.

14. The process of claim 13, further comprising approving or rejecting the tow based on the analysis of the image for defects.

15. The process of claim 13, wherein the light is a visible light.

16. The process of claim 15, wherein the capture of the image is performed with a camera.

17. The process of claim 13, wherein the source of the at least one light is at a distance of less than 20 meters from the dried tow band.

18. The process of claim 13, wherein the image is analyzed using computer software.

19. The process of claim 13, further comprising assigning a score to a defect detected during the analysis step.

20. The process of claim 13, wherein the cellulose acetate tow produced has less defects compared to cellulose acetate tow producing using conventional methods.
